(19) United States
(12) Patent Application Publication
(10) Pub. No.: US 2024/0410508 A1
(43) Pub. Date: Dec. 12, 2024

(54) WATER HEATER EXPANSION TANK FITTING TEES

(71) Applicant: RELIANCE WORLDWIDE CORPORATION, Atlanta, GA (US)

(72) Inventor: Virgil O'NEIL, Poway, CA (US)

(21) Appl. No.: 18/699,832

(22) PCT Filed: Oct. 10, 2022
(86) PCT No.: PCT/US2022/077845

§ 371 Date: Apr. 9, 2024

Related U.S. Application Data
(60) Provisional application No. 63/256,016, filed on Oct. 15, 2021.
(60) Provisional application No. 63/256,012, filed on Oct. 15, 2021.

(51) Int. Cl. F16L 41/02; F24H 9/13

(52) U.S. Cl. CPC F16L 41/021; F24H 9/13

(57) ABSTRACT

A water system that includes a prefabricated fitting tee for use with a water heater. The prefabricated fitting tee includes a fitting tee body that has a first, second, and third port. The first and third ports are aligned along a main axis and the second port is aligned along an axis angled relative to the main axis. The fitting tee body defines an interior passageway that is in fluid communication with the first, second, and third ports. One of the first and second ports connects to a water inlet conduit for supplying water from an external source, the other one of the first and second ports connects to a pressure relief or pressure absorption mechanism. A swivel nut is rotatably mounted at the third port of the prefabricated fitting tee to provide an interconnection to the water heater.

### CROSS-REFERENCE TO RELATED APPLICATION

This application claims the benefit of U.S. Provisional Application Ser. No. 63/256,012, filed Oct. 15, 2021 and U.S. Provisional Application Ser. No. 63/256,016, filed Oct. 15, 2021.

### INCORPORATION BY REFERENCE

U.S. Provisional Application Ser. No. 63/256,012, filed Oct. 15, 2021 and U.S. Provisional Application Ser. No. 63/256,016, filed Oct. 15, 2021 are hereby incorporated by reference as if set forth in their entireties.

### TECHNICAL FIELD

The present disclosure relates generally to plumbing systems. More specifically, the present disclosure relates to plumbing fittings for use with water heaters or other plumbing systems.

### BACKGROUND

Water heaters that are installed in a closed pipe system for both commercial and residential applications typically are required to include a pressure relief or pressure absorption mechanism per most North American jurisdiction plumbing codes. Typically, installers would combine a number of fittings and pipe sections together to comply with the plumbing codes when connecting a pressure relief or pressure absorption mechanism with a water heater. This results in multiple fittings and pipe arrangements being fixed together in the field.

The present disclosure addresses the foregoing and other related, and unrelated, issues.

### SUMMARY

The present disclosure relates to a prefabricated tee fitting for use in a water system. The prefabricated tee fitting is designed to be used when installing a thermal expansion tank onto a water heater in a residential or commercial building. The thermal expansion tank typically is used in a closed piping system to act as a shock or pressure absorber when there is expansion and contraction within the water system. That is, the expansion tank can function as a pressure cushion or dampener to take up the expansion and contraction energy, e.g., to meet most plumbing codes. The prefabricated tee fitting is configured to allow the thermal expansion tank to be mounted in either a horizontal or vertical orientation.

The prefabricated tee fitting can also rotate 360 degrees about a mounting axis that is generally vertical to be fixed in any desired orientation. That is, the final position or orientation of the prefabricated tee fitting is not limited when the prefabricated tee fitting is mounted relative to the water heater to provide adequate fluid flow operation.

Aspects of the present disclosure relate to a water system that includes a prefabricated fitting tee for use with a water heater. The prefabricated fitting tee includes a fitting tee body that has a first port, a second port, and a third port. The first and third ports can be aligned along a main axis and the second port can be aligned along an axis angled relative to the main axis.

The fitting tee body can define an interior passageway that is in fluid communication with the first, second, and third ports. One of the first and second ports is configured for connecting to a water inlet conduit for supplying water from an external source, the other one of the first and second ports is configured for connecting to a pressure relief or pressure absorption mechanism. The prefabricated fitting tee may not include a check valve for preventing flow from the first port to the third port and no check valve for preventing flow from the second port to the third port.

A swivel nut can be rotatably mounted at the third port of the prefabricated fitting tee to provide an interconnection to the water heater. When the swivel nut is in a first condition, the swivel nut allows the prefabricated fitting tee to be rotated relative to the water heater about the main axis to allow a rotational orientation of the second port to be established. When the swivel nut is in a second condition, the swivel nut clamps the prefabricated fitting tee in the established rotational orientation.

Further aspects of the present disclosure relate to a hot water recirculation system that includes a recirculation arrangement tee for use with a water heater. The hot water recirculation system includes a recirculation arrangement tee including a fitting tee body. The fitting tee body can define an interior passageway in fluid communication with a first port, a second port, a third port, and a fourth port defined by the recirculation arrangement tee.

The first and fourth ports can be aligned along a main axis, and the second and third ports can be aligned along an axis angled relative to the main axis. The first port can provide a connection for a pressure relief or pressure absorption mechanism, the second port can provide a connection for a water inlet conduit, the third port can provide a connection to a recirculation line, e.g., including a pipe, and the fourth port can provide a connection to the water heater. The recirculation arrangement tee may not include a check valve for preventing flow from the first port to the fourth port and no check valve for preventing flow from the second port to the fourth port.

A swivel nut can be rotatably mounted at the fourth port of the recirculation arrangement tee to provide an interconnection to the water heater. When the swivel nut is in a first condition, the swivel nut allows the recirculation arrangement tee to be rotated relative to the water heater about the main axis to allow a rotational orientation of the second and third ports to be established. When the swivel nut is in a second condition, the swivel nut clamps the recirculation arrangement tee in the established rotational orientation.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a schematic view of an example water piping system including a fitting tee with a swivel nut, a thermal expansion tank, a cold-water inlet conduit, and a water heater in accordance with principles of the present disclosure.

FIG. 2 illustrates a schematic view of the water piping system of FIG. 1 with the thermal expansion tank and the cold-water inlet conduit in different positions.

FIG. 3 illustrates a schematic plan view of the fitting tee of FIGS. 1-2.

FIG. 4 illustrates a cross-sectional view of the fitting tee of FIG. 3.

FIG. 5 illustrates a perspective view of the fitting tee of FIG. 3.

FIG. 6 illustrates a cross-sectional view of the fitting tee of FIG. 3 with an alternative threaded component in accordance with the principles of the present disclosure.

FIG. 7 illustrates a perspective view of the fitting tee of FIG. 6.

FIG. 8 illustrates a plan view of the fitting tee of FIG. 7.

FIG. 9 illustrates a perspective view of the threaded component shown in FIGS. 6-8.

FIG. 10 illustrates an end view of the threaded component of FIG. 9.

FIG. 11 illustrates a cross-sectional view taken along line 11-11 of FIG. 10.

FIG. 12 illustrates a schematic view of a hot water recirculation system including a recirculation arrangement tee with a swivel nut, a thermal expansion tank, a cold-water inlet conduit, a recirculation line, and a water heater in accordance with the principles of the present disclosure.

FIG. 13 illustrates an enlarged view of a portion of the hot water recirculation system of FIG. 12.

FIG. 14 illustrates an end view of the recirculation arrangement tee of FIG. 12 without the swivel nut attached.

FIG. 15 illustrates a cross-sectional view taken along line 15-15 of FIG. 14 (less the swivel nut).

FIG. 16 illustrates an enlarged view of a portion of FIG. 15.

FIG. 17 illustrates a perspective view of the recirculation arrangement tee of FIG. 12 with check valves in accordance with the principles of the present disclosure.

FIG. 18 illustrates a cross-sectional view of the recirculation arrangement tee of FIG. 17.

FIG. 19 illustrates a perspective view of another example recirculation arrangement tee with an alternative threaded component in accordance with the principles of the present disclosure.

FIG. 20 illustrates a cross-sectional view of the recirculation arrangement tee of FIG. 19.

### DETAILED DESCRIPTION

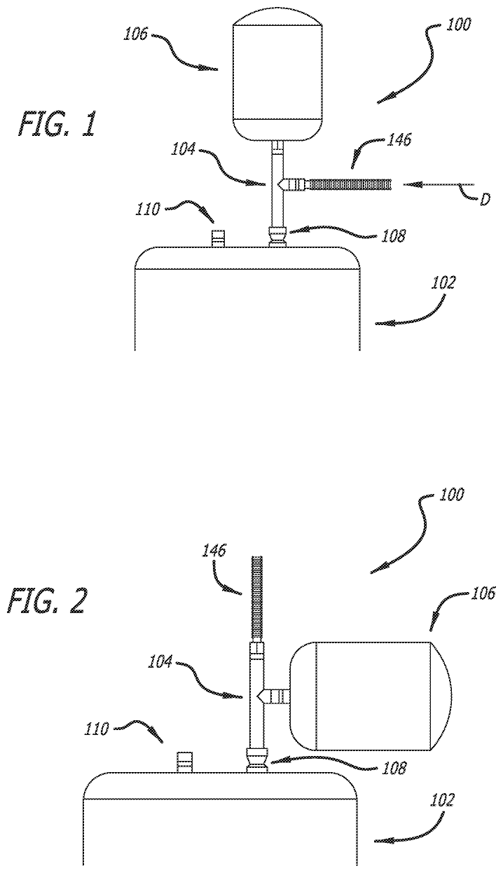

FIGS. 1-2. show a water piping system 100 that includes an example water heater 102, an example fitting tee 104 (e.g., valve arrangement tee), and a pressure relief mechanism, shown as a thermal expansion tank 106. In other examples, the pressure relief mechanism may include a thermal relief valve or a thermal expansion ball valve. The thermal expansion tank 106 is designed to protect the water heater 102 and other equipment and fixtures in the plumbing system from excess pressure. The water heater 102 has an inlet line, e.g., including a pipe 108 and an outlet line, e.g., including a pipe 110. During operation, cold water can be supplied from a water source to the water heater 102 via the inlet pipe 108 and hot water can be drawn from the water heater 102 through the outlet pipe 110. The water heater 102 includes an internal heat exchanger that utilizes heating elements (e.g., gas burners or electric heating elements) to produce heat for exchange with water flowing through the internal heat exchanger.

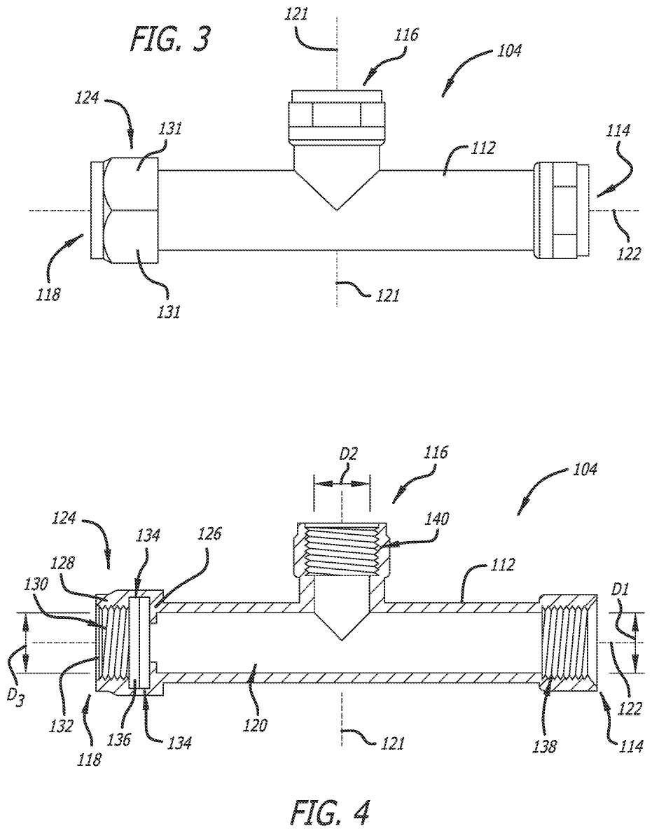

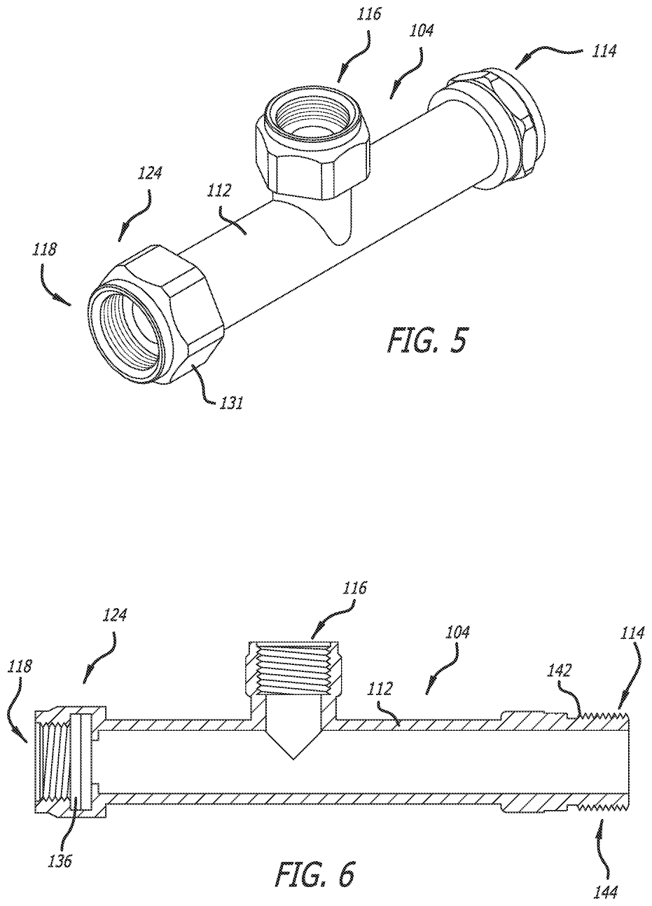

Referring to FIGS. 3-5, the fitting tee 104 can be a prefabricated, unitary tee, that includes an integral body 112. Although alternatives are possible, the body 112 may typically be formed from metal, such as, for example, brass, although other metallic materials, composite materials, etc., or combinations thereof can be employed without departing from the scope of the present disclosure. As an example, the fitting tee 104 is depicted schematically having a first port 114, a second port 116, and a third port 118. The body 112 defines an interior passageway 120 that is in fluid communication with the first, second, and third ports 114, 116, 118. The fitting tee 104 is generally T-shaped with the first port 114 and the third port 118 aligned with one another along a mounting axis 122 (e.g., a main axis, a generally vertical axis). The second port 116 is oriented generally perpendicular to the first and third ports 114, 118; however, other angles, such as angles less than or greater than 90 degrees are possible without departing from the scope of the present disclosure. The first and third ports 114, 118 can be aligned along the mounting axis 122 and the second port can be aligned along an axis 121 angled relative to the mounting axis 122. The mounting axis 122 is shown in extension through the passageway 120 of the fitting tee 104.

Turning again to FIGS. 1-2, the third port 118 of the fitting tee 104 can be a mounting port that mounts the fitting tee 104 to a tank of a fluid system using a swivel nut 124 (e.g., a threaded coupling) that rotates relative to the body 112. In the example depicted, the fitting tee 104 is shown mounted to the water heater 102 at the inlet pipe 108, cold-water side. The fitting tee 104 is an improvement over conventional tees because the final orientation of the fitting tee 104, particularly the second port/branch 116, is not dependent upon when the tee is tightened to its final assembled condition on the water heater 102.

The swivel nut 124 allows the fitting tee 104 to be rotated through 360 degrees about the mounting axis 122 to accommodate a plurality of selectable orientations or configurations. In this regard, the second port 116 can be configured in any selectable orientation or configuration resulting from a 360-degree rotation of the body 112 around the mounting axis 122 relative to the water heater 102. That is, the second port 116 in extension between the first and third ports 114, 118 along a path perpendicular to the mounting axis 122, can be oriented in any position resulting from a 360 degree rotation of the fitting tee 104 about the mounting axis 122. As such, an installer is not limited as to the final orientation of the side port/branch of the fitting tee 104 because the attachment of the fitting tee 104 is not dependent upon when the fitting tee 104 completes its rotation and becomes tight and secured to the water heater 102. Rather, the attachment of the fitting tee 104 to the water heater 102 is by the swivel nut 124. The swivel nut 124 can be carried with the fitting tee 104 to provide an interconnection between the pressure relief mechanism 106 and the water heater 102. When the swivel nut 124 is in a first condition, the fitting tee 104 can be rotatable through 360 degrees relative to the water heater 102 to a selectable orientation. When the swivel nut 124 is rotated to a second condition, the fitting tee 104 can be locked in the selectable orientation against further movement. The first condition of the swivel nut 124 can be a loose, releasable position and the second condition of the swivel nut 124 can be a secured, locked position.

The body 112 of the fitting tee 104 can include an external flange 126 on the third port 118. The external flange 126 is configured to capture the swivel nut 124. The swivel nut 124 includes a sleeve 128 with internal threads 130 (e.g., female threads) that extend from an interior wall 132 of the sleeve 128. The sleeve 128 can include an external wrench interface, such as a plurality of flats 131. The internal threads 130 are configured to threadedly engage external threads (e.g., male threads on the inlet of the water heater). As depicted, the external flange 126 extends from the body 112 and is adapted to be captured within an annular recess 134 defined in the sleeve 128.

In certain examples, the inlet pipe 108 includes a ¾ inch male threaded connection. The internal threads 130 of the swivel nut 124 also provide a ¾ inch connection that can threadedly engage the male threaded connection of the inlet pipe 108 of the water heater 102 to attach the fitting tee 104 to the water heater 102. When the internal threads 130 of the swivel nut 124 engage the male threaded connection of the inlet pipe 108, the swivel nut 124 can be rotated in a securing direction on the inlet pipe 108 (or vice versa in a disconnecting direction until the swivel nut 124 is threaded off the inlet pipe 108) so that the fitting tee 104 is drawn toward and onto the water heater 102 while allowing for 360-degree rotation of the fitting tee 104.

The swivel nut 124 can provide the fitting tee 104 with the ability to rotate 360 degrees for orienting the branch of the fitting tee 104 or the second port 116 of the fitting tee 104 where desired. The swivel nut 124 can be rotatably mounted at the third port 118 of the fitting tee 104 to provide an interconnection to the water heater 102. When the swivel nut 124 is in a first condition, the swivel nut 124 allows the fitting tee 104 to be rotated relative to the water heater 102 about the main axis 122 to allow a rotational orientation of the second port 116 to be established. When the swivel nut 124 is in a second condition, the swivel nut 124 clamps the fitting tee 104 in the established rotational orientation.

Thus, as the swivel nut 124 is loosened, the fitting tee 104 can be rotated through 360 degrees to any orientation. The swivel nut 124 allows an installer to orient the fitting tee 104 in any desired position before screwing the swivel nut 124 down over the inlet pipe 108. In certain examples, the swivel nut 124 may be loosely attached to the inlet pipe 108 of the water heater 102 such that the fitting tee 104 can still be rotated about the mounting axis 122. When the swivel nut 124 is tightened, it clamps or otherwise tightens the fitting tee 104 at the desired rotational orientation about the mounting axis 122 relative to the water heater 102. That is, once the swivel nut 124 is tightened over the inlet pipe 108, the fitting tee 104 can be locked against further movement in its desired orientation.

A sealing gasket 136 can be seated in the annular recess 134. The sealing gasket 136 is made of a resilient material, such as an elastomeric or polymeric material, and can fit snugly within the swivel nut 124. When the swivel nut 124 is attached to the water heater 102, the sealing gasket 136 is clamped between the swivel nut 124 and an end of the inlet pipe 108 to provide a reliable seal.

Typically, the first, second, and third ports have a respective first, second, and third inside cross-dimension D1, D2, D3 that are at least 15 mm, but alternatives are possible, such as at least 10 mm, at least 11 mm, at least 12 mm, at least 13 mm, at least 14 mm, at least 16 mm or more. Usually, the third cross-dimension D3 of the third port 118 is larger than the first and second cross-dimensions D1, D2, of the first and second ports 114, 116. In one example, the third cross-dimension D3 of the third port 118 is at least 31 mm, and in some examples, the first, second, and third cross-dimensions D1, D2, D3 are no more than 35 mm, although alternatives are possible.

In certain examples, the first and second ports 114, 116 of the fitting tee 104 can be provided with a push or push-fit connection or with a press connection, or a threaded connection, as desired. In one example, the first and second ports 114, 116 can include female threads (e.g., one or more female threaded portions). In certain examples, the first and second ports 114, 116 of the fitting tee 104 can include threads that allow it to be connected to a pipe, expansion chamber, thermal expansion relief valve, thermal expansion ball valve, pressure relief mechanism, or other component.

In certain examples, the first and second ports 114, 116 can each include a ¾ inch female threaded connection 138, 140 to facilitate a connection to the thermal expansion tank 106. The thermal expansion tank 106 is designed to act as a shock observer when there is expansion and contraction within the water system. The fitting tee 104 can be made of brass such that it has sufficient strength to support the thermal expansion tank 106 properly. Thus, the fitting tee 104 has an acceptable structure to securely mount the thermal expansion tank 106 to the water heater 102 so that an external bracket is not needed to meet plumbing code requirements.

As depicted in FIGS. 1-2, the thermal expansion tank 106 can be attached to the fitting tee 104 in two different mounting positions. That is, the thermal expansion tank 106 can be mounted at the first port 114 in a vertical position or be mounted at the second port 116 in a horizontal position. Determining the optimal mounting position of the thermal expansion tank 106 can depend on the space or environment that yields the most convenient location. It will be appreciated that there is no shut-off or check valve between the thermal expansion tank 106 and the water heater 102 to ensure continuous water flow therebetween for the safe operation of the water heater 102. This design eliminates the risk of blowing out the water heater 102 due to a possible inadvertent shut-off of the water.

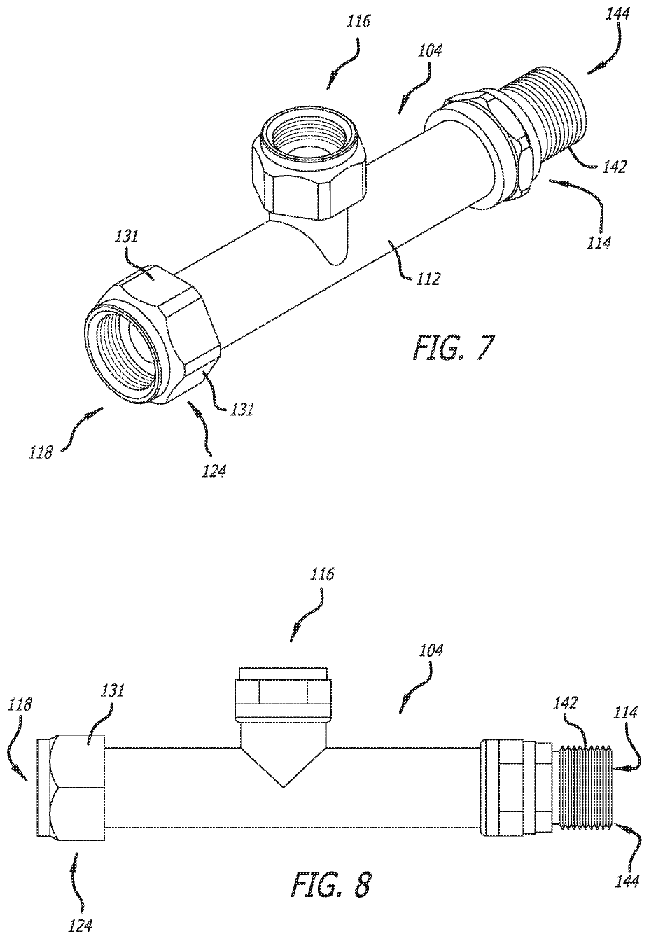

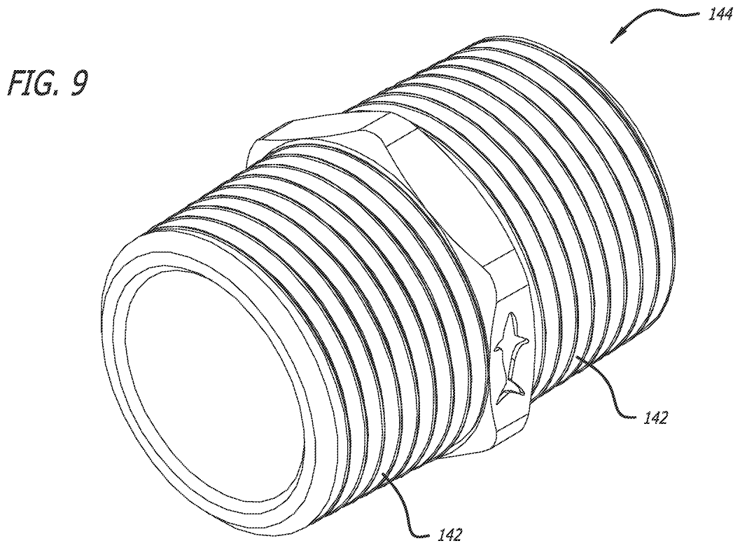

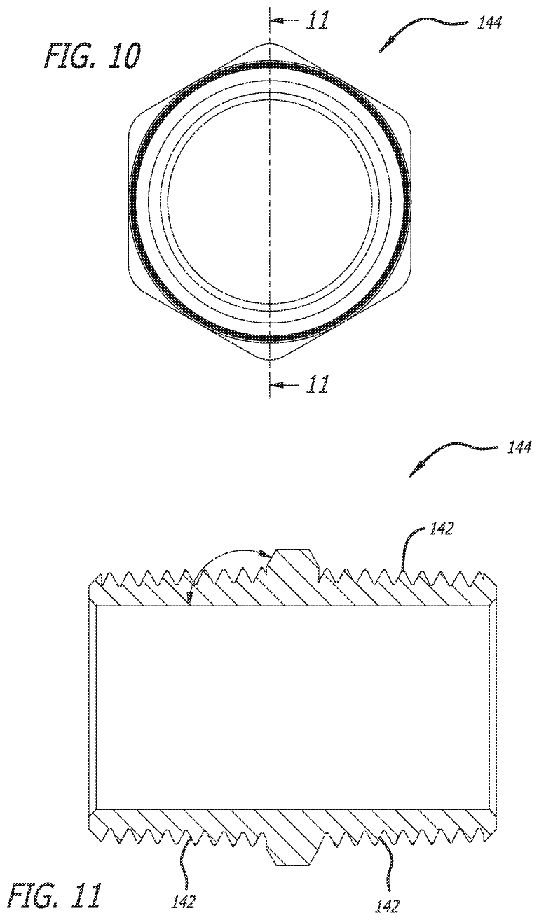

FIGS. 6-8 show the fitting tee 104 with an adapter in accordance with the principles of the present disclosure. The first and second ports 114, 116 of the fitting tee 104 may be modified to have a ¾ inch male threaded connection 142 rather than a female connection. A separate, threaded brass nipple or adapter 144 (see FIGS. 9-11) may be screwed into one of the first and second ports 114, 116 by installer to provide the ¾ inch male threaded connection 142 to facilitate a direct connection to a cold-water supply conduit 146 (i.e., incoming water flex connector), as generally indicated in FIGS. 1-2. For example, the adapter 154 may be a ¾ inch male threaded adapter that can be screwed into ¾ female threads of one of the first and second ports 114, 116 for connecting the cold-water supply conduit 146. The cold-water supply conduit 146 may be a stainless-steel corrugated flex connector through which incoming cold-water flows to feed the water heater 102.

In certain examples, an installer or plumber may connect the adapter 144 into either the first or second ports 114, 116 for attaching the cold-water supply conduit 146. The adapter 144 allows the cold-water supply conduit 146 to be reconfigured between multiple positions (i.e., vertical, horizontal) as shown in FIGS. 1-2. That is, the adapter 144 provides an installer the flexibility on how to arrange the thermal expansion tank 106 and the cold-water supply conduit 146 on the fitting tee 104.

FIGS. 6-8 show the first port 114 modified with the adapter 144. The ¾ inch male threaded connection 142 is shown threaded into the first port 114 to provide a connection for the cold-water supply conduit 146. Cold water from an external source can flow into the cold-water supply conduit 146 through a one-way check valve such that cold water flows in direction D (see FIG. 1) from right to left and into the passageway 120 of the fitting tee 104, preventing backflow from the cold-water supply conduit 146.

It would be appreciated that the first and second ports 114, 116 of the fitting tees 104 may be fabricated as either two female threaded ports or two male threaded ports. With male pipe threads, a ¾ inch coupling can be used rather than a ¾ inch threaded adapter. As such, the thermal expansion tank 106 and the cold-water supply conduit 146 may be connected to either one of the first and second ports 114, 116, configured as either female or male threads by using a coupling or adapter 144. If male pipe threads are used on the ports, the incoming cold-water line would be ready for connection, but the thermal expansion tank would require installation of a threaded coupling for threading over the male pipe threads.

Regarding the fitting tee 104, the cold-water supply conduit 146 can be attached to one of the first and second ports 114, 116 and the thermal expansion tank 106 can be mounted to the other one of the first and second ports 114, 116. The thermal expansion tank 106 can be mounted without modification or use of the adapter 144. That is, if the first and second ports 114, 116 are provided with female threads, there is no need for the adapter 144 when mounting the thermal expansion tank 106. Both the cold-water supply conduit 146 and the inlet pipe 108 of the water heater 102 can be in fluid connection with the thermal expansion tank 106.

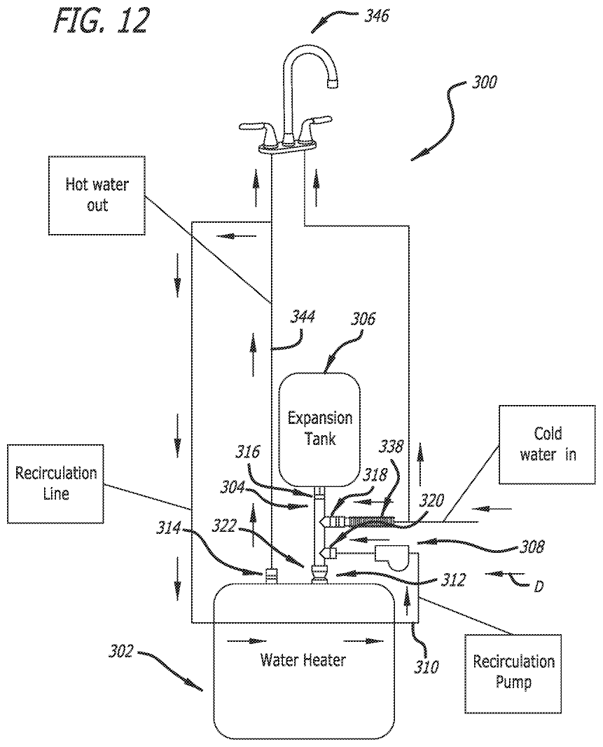

Turning to FIG. 12, a diagram of a hot water recirculation system 300 is depicted in accordance with the principles of the present disclosure. The hot water recirculation system 300 includes a water heater 302, a recirculation fitting tee 304 (e.g., a recirculation valve arrangement tee), a thermal expansion tank 306, recirculation pump 308, and a recirculation line 310. The recirculation fitting tee 304 is similar to the fitting tee 104 shown in FIGS. 1-2 except that the recirculation fitting tee 304 is integrated with the recirculation line 310. The water heater 302 has an inlet 312 for cold water and an outlet 314 for hot water.

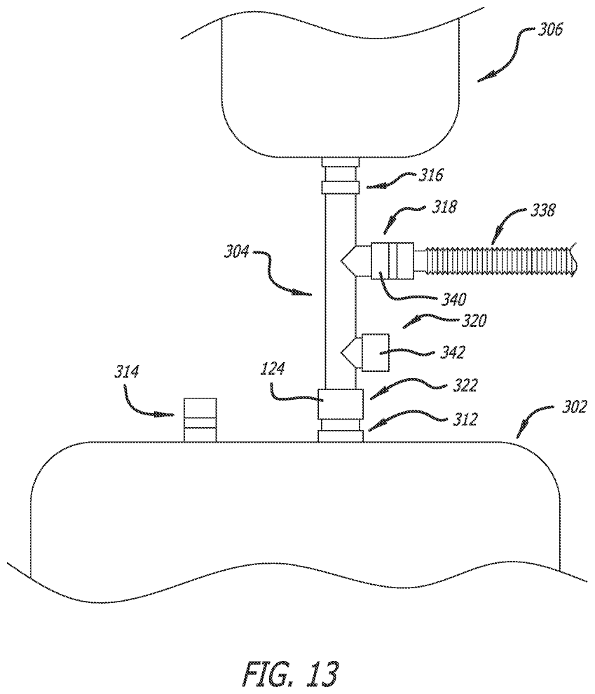

Referring to FIG. 13, the recirculation fitting tee 304 can be attached to the water heater 302 using a swivel type connection as described above. The recirculation fitting tee 304 includes an external flange 325 configured to capture the swivel nut 124. The swivel nut 124 can facilitate a direct connection of the recirculation fitting tee 304 to the cold-water inlet 312 of the water heater 302 while allowing for 360-degree rotation of the recirculation fitting tee 304 to achieve a desired orientation. That is, the swivel nut 124 allows the recirculation fitting tee 304 to move through 360 degrees to a selected orientation before being secured in the selected orientation.

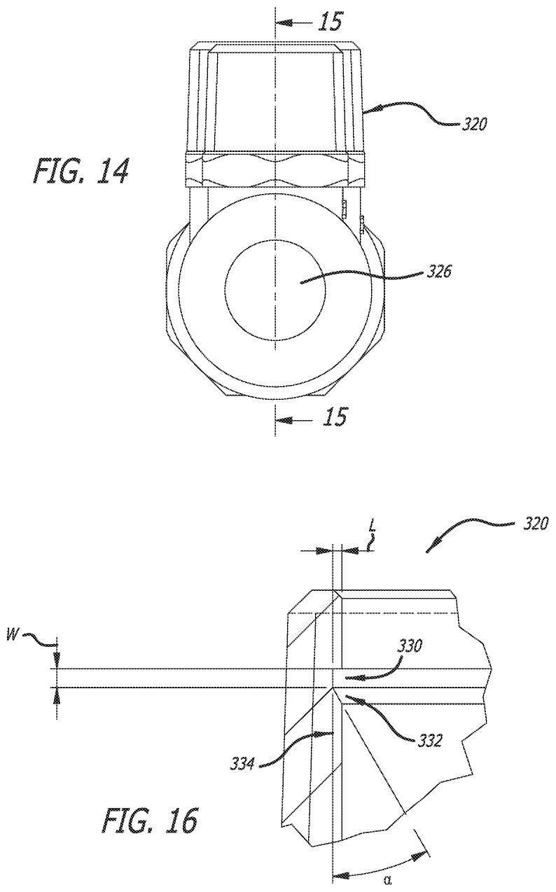

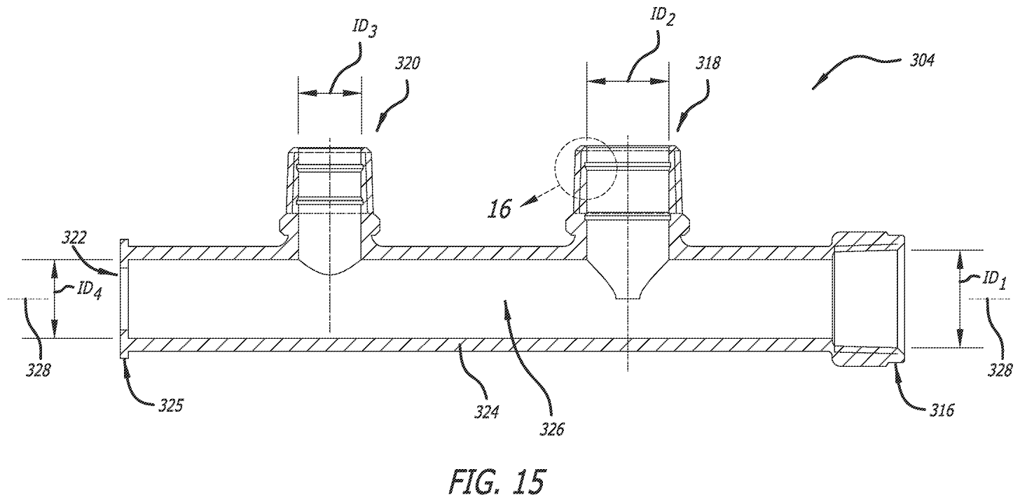

Turning to FIGS. 14-16, the recirculation fitting tee 304 includes a first port 316, a second port 318, a third port 320, and a fourth port 322. The recirculation fitting tee 304 can be fabricated with either built-in check valves or simply have threaded ports for installing check valves as needed. The recirculation fitting tee 304 includes an integral body 324 (see FIG. 15). The body 324 defines an interior passageway 326 that is in fluid communication with the first, second, third, and fourth ports 316, 318, 320, 322. The first port 316 and the fourth port 322 are aligned with one another along a mounting axis 328. The second and third ports 318, 320 are oriented generally perpendicular to the first and fourth ports 316, 322.

In certain examples, the first port 316 may have a first inner cross-dimension ID1, the second port 318 may have a second inner cross-dimension ID2, the third port 320 may have a third inner cross-dimension ID3, and the fourth port 322 may have a fourth inner cross-dimension ID4. In certain examples, the first, second, third, and fourth inner cross-dimensions ID1-4, may be between about 10 millimeters to about 35 millimeters (mm), although alternatives are possible.

In certain examples, the first, second, third, and fourth inner cross-dimensions ID1-4 of the first, second, third, and fourth ports 316, 318, 320, 322 may be no more than 40 mm, although alternatives are possible. In certain examples, the first, second, third, and fourth inner cross-dimensions ID1-4 of the first, second, third, and fourth ports 316, 318, 320, 322 may be at least 10 mm, although alternatives are possible, such as at least 8 mm, at least 9 mm, etc.

In certain examples, the first inner cross-dimension ID1 of the first port 316 may be larger than the second, third, and fourth inner cross-dimensions ID2-4 of the second, third, and fourth ports 318, 320, 322. For example, the first inner cross-dimension ID1 of the first port 316 may be about 25 mm. In certain examples, the second inner cross-dimension of the second port 318 may be larger than the third and fourth inner cross-dimensions ID3-4 of the third and fourth ports 320, 322. In certain examples, the third and fourth ports 320, 322 may have the same inner cross-dimension. The second inner cross-dimension ID2 of the second port 318 may be about 20 mm, although alternatives are possible. The third and fourth inner cross-dimensions ID3-4 may be about 15 mm, although alternatives are possible.

Referring to FIG. 16, the third port 320 can define a shoulder 330 that extends from the inner cross-dimension ID3 a length L and width W for capturing check valves. An angled portion 332 of the shoulder 330 may extend at an angle α relative to internal threads 334 of the third port 320.

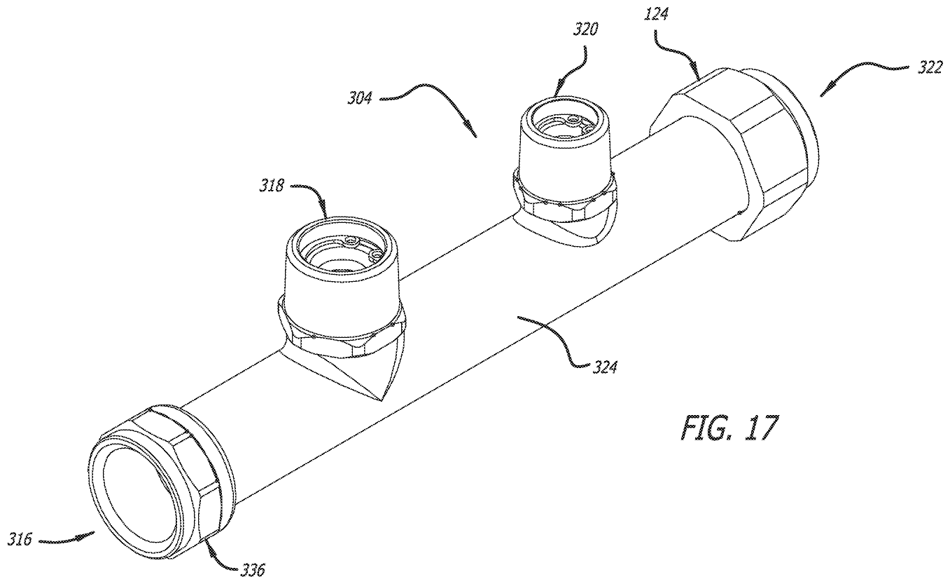

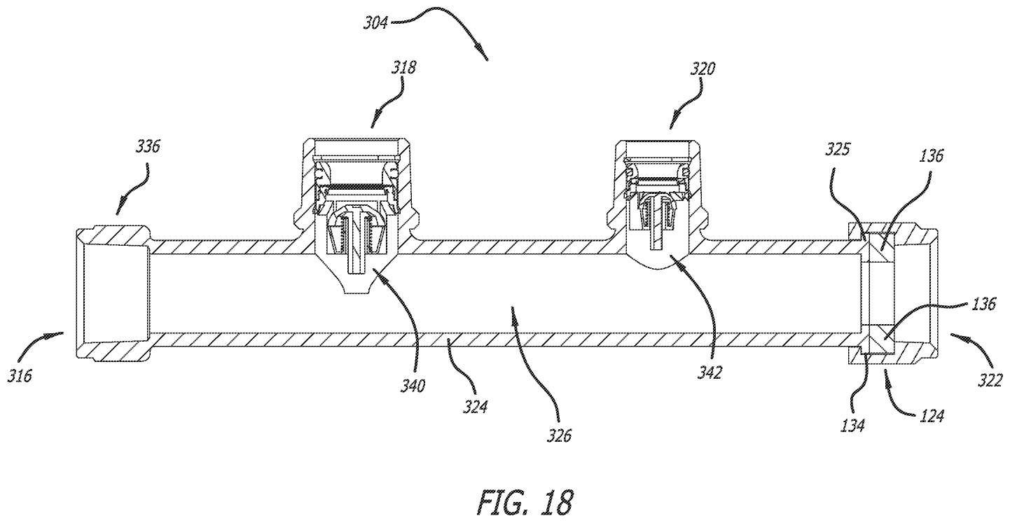

Turning to FIGS. 17-18, the recirculation fitting tee 304 is depicted with the swivel nut 124 attached for connecting the recirculation fitting tee 304 to the water heater 302, allowing for 360-degree rotation as previously described. In the example depicted, the first port 316 includes a nut 336 for attaching the thermal expansion tank 306 in an upright or vertical position as shown in FIGS. 12-13. It will be appreciated that there is no shut-off valve or check valve between the water heater 302 and the thermal expansion tank 306.

A cold-water supply conduit 338 (see FIGS. 12-13) can be connected to the second port 318 of the recirculation fitting tee 304. The second port 318 can include a one-way check valve 340 to keep the cold water flowing in one direction through the second port 318, preventing backflow from the recirculation fitting tee 304 toward the cold-water supply conduit 324. The third port 320 may be provided with a one-way check valve 342 allowing for return hot water flow in the direction D, right to left. This prevents flow from the recirculation fitting tee 304 toward the recirculation line 310.

The third port 320 can be a ½ inch inlet port that can be coupled to a pipe, a valve, or any other plumbing fixture for connecting the recirculation line 310. The recirculation line 310 can be connected to the water heater 302 via the recirculation fitting tee 304 and be isolated from the thermal expansion tank 306. The hot water recirculation system 300 can be configured for whole house hot water recirculation with the water heater 302. The hot water recirculation system 300 may be connected to a heating element or a burner of the water heater 302 as a hot water return heat source. Water flowing through the cold-water inlet 312 of the water heater 302 keeps the hot water recirculation system 300 flowing in a pre-determined direction toward the water heater so that the recirculation line 310 may maintain a constant water temperature throughout the hot water recirculation system 300.

The recirculation line 310 includes the recirculation pump 308 for pumping previously heated warm water from a hot water distribution pipeline 344 back through the recirculation line 310 to the water heater 302 for reheating warm water that can be sent back through the hot water distribution pipeline 344 for use at a facet 346 (see FIG. 12) and/or other plumbing fixtures. That is, the recirculation pump 308 continues to circulate heated water around the recirculation line 310. During times when the hot water valve at the facet is closed and water is just being re-circulated, the cold-water source remains closed. But, when water is draw from the hot water tank through the portion of the plumbing system serving the facet, then the old water source opens and cold water will flow into the hot water tank to be heated. Because of the one-way check valve 342, the incoming cold-water does not defeat the purpose of the hot water recirculation system 300. The cold-water input into the water heater 302 of the hot water recirculation system 300 system does not become warm due to any mixing of the cold-water with the hot water recirculation system 330.

The recirculation pump 308 can be structured to function in accordance to the water heater 302 requirements and flow rates. The recirculation pump 308 may be a continuous pump or an intermittent pump. In certain examples, the recirculation pump 308 can be operated on a timer for providing a flow of hot water that moves through the hot water recirculation system 300 such that there is immediate hot water available throughout the piping system. The timer can be set by a user to activate the recirculation pump 308 to create a flow of warm water through the recirculation line 310 and the water heater 302. In other examples, the recirculation pump 308 can be regulated strictly by electricity, such as without a mechanical timer.

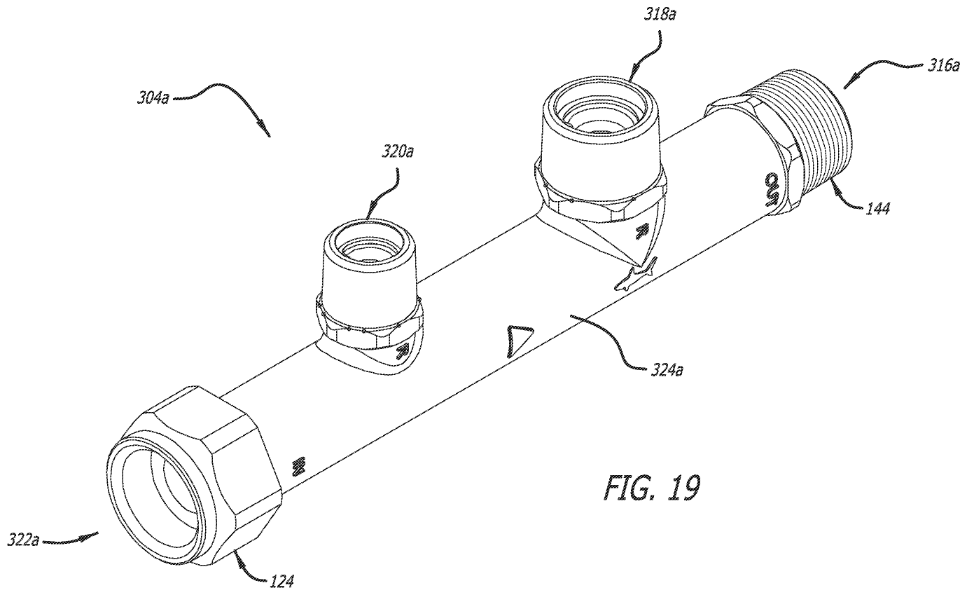

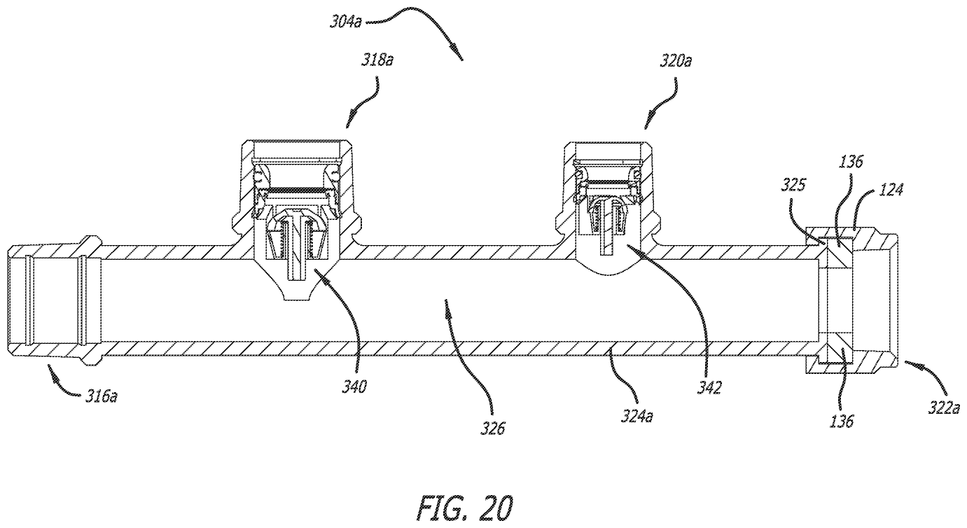

Turning to FIGS. 19-20, another example recirculation fitting tee 304a is depicted in accordance with the principles of the present disclosure. The recirculation fitting tee 304a has similar features descried above with reference to the recirculation fitting tee 304 shown in FIGS. 17-18 except the first port 316a shown in FIG. 19 is fitted with the adapter 144 for connection with the thermal expansion tank 306 and the first port 316a shown in FIG. 20 includes a coupler.

### EXAMPLE ASPECTS OF THE DISCLOSURE

Aspect 1. A water piping system comprising:
a prefabricated fitting tee for use with a water heater, the prefabricated fitting tee including:
   a fitting tee body having a first port, a second port, and a third port, the first and third ports being aligned along a main axis and the second port being aligned along an axis angled relative to the main axis, the fitting tee body defining an interior passageway that is in fluid communication with the first, second, and third ports, wherein one of the first and second ports is configured for connecting to a water inlet conduit for supplying water from an external source, wherein the other one of the first and second ports is configured for connecting to a pressure relief or pressure absorption mechanism, and wherein the prefabricated fitting tee does not include a check valve for preventing flow from the first port to the third port and no check valve for preventing flow from the second port to the third port; and
   a swivel nut rotatably mounted at the third port of the prefabricated fitting tee to provide an interconnection to the water heater, wherein, when the swivel nut is in a first condition, the swivel nut allows the prefabricated fitting tee to be rotated relative to the water heater about the main axis to allow a rotational orientation of the second port to be established, and wherein, when the swivel nut is in a second condition, the swivel nut clamps the prefabricated fitting tee in the established rotational orientation.
Aspect 2. The water piping system of aspect 1, wherein the first condition is a loose state.
Aspect 3. The water piping system of aspect 1, wherein the second condition is a tightened state.
Aspect 4. The water piping system of aspect 1, wherein the pressure relief mechanism is a thermal expansion tank, a thermal relief valve, or a thermal expansion ball valve.
Aspect 5. The water piping system of aspect 1, wherein the pressure relief mechanism is adapted to be horizontally mounted when the pressure relief mechanism is coupled to the second port and the water inlet conduit is coupled to the first port.
Aspect 6. The water piping system of aspect 1, wherein the pressure relief mechanism is adapted to be vertically mounted when the pressure relieve mechanism is coupled to the first port and the water inlet conduit is coupled to the second port.
Aspect 7. The water piping system of aspect 1, wherein the water inlet conduit forms a cold-water inlet for the water heater.
Aspect 8. The water piping system of aspect 1, wherein the prefabricated tee fitting is generally T-shaped.
Aspect 9. The water piping system of aspect 1, wherein the first port and the third port are aligned with one another.
Aspect 10. The water piping system of aspect 1, wherein the first and second ports include female threads.
Aspect 11. A component connection system comprising:
a prefabricated fitting tee having a fitting tee body that includes a first port, a second port, and a third port, the first and third ports being aligned along a main axis and the second port being aligned along an axis angled relative to the main axis, the fitting tee body defining an interior passageway that is in fluid communication with the first, second, and third ports, wherein one of the first and second ports are configured for connecting to a water inlet conduit for supplying water from an external source;
a water inlet conduit connected to one of the first and second ports for supplying water from an external source, and a pressure relief mechanism being provided at the other one of the first and second ports, wherein the prefabricated fitting tee does not include a check valve for preventing flow from the first port to the third port and no check valve for preventing flow from the second port to the third port;
a swivel nut rotatably mounted at the third port of the prefabricated fitting tee to provide an interconnection to the water heater, wherein, when the swivel nut is in a first condition, the swivel nut allows the prefabricated fitting tee to be rotated relative to the water heater about the main axis to allow a rotational orientation of the second port to be established, and wherein, when the swivel nut is in a second condition, the swivel nut clamps the prefabricated fitting tee in the established rotational orientation; and
a threaded component attachable to the first and second ports for providing male and/or female threaded connections.
Aspect 12. The component connection system of aspect 11, wherein the threaded component is a ¾ inch female threaded coupling.
Aspect 13. The component connection system of aspect 11, wherein the threaded component is a ¾ inch male threaded nipple.
Aspect 14. The component connection system of aspect 11, wherein the first condition is a loose state.
Aspect 15. The component connection system of aspect 11, wherein the second condition is a tightened state.
Aspect 16. The component connection system of aspect 11, wherein the pressure relief mechanism is a thermal expansion tank, a thermal relief valve, or a thermal expansion ball valve.
Aspect 17. The component connection system of aspect 11, wherein the pressure relief mechanism is adapted to be horizontally mounted when the pressure relief mechanism is coupled to the second port and the water inlet conduit is coupled to the first port.
Aspect 18. The component connection system of aspect 11, wherein the pressure relief mechanism is adapted to be vertically mounted when the pressure relieve mechanism is coupled to the first port and the water inlet conduit is coupled to the second port.
Aspect 19. The component connection system of aspect 11, wherein the prefabricated tee fitting is generally T-shaped, wherein the first port and the third port are aligned with one another.
Aspect 20. The component connection system of aspect 11, wherein the first and second ports include female threads.
Aspect 21. A water recirculation system including a recirculation arrangement tee for use with a water heater, the hot water recirculation system comprising:
a recirculation arrangement tee including a fitting tee body, the fitting tee body defining an interior passageway in fluid communication with a first port, a second port, a third port, and a fourth port defined by the recirculation arrangement tee, the first and fourth ports being aligned along a main axis, and the second and third ports being aligned along an axis angled relative to the main axis, wherein the first port provides a connection for a pressure relief mechanism, the second port provides a connection for a water inlet conduit, the third port provides a connection to a recirculation pipe, and the fourth port provides a connection to the water heater, wherein the recirculation arrangement tee does not include a check valve for preventing flow from the first port to the fourth port and no check valve for preventing flow from the second port to the fourth port; and
a swivel nut rotatably mounted at the fourth port of the recirculation arrangement tee to provide an interconnection to the water heater, wherein, when the swivel nut is in a first condition, the swivel nut allows the recirculation arrangement tee to be rotated relative to the water heater about the main axis to allow a rotational orientation of the second and third ports to be established, and wherein, when the swivel nut is in a second condition, the swivel nut clamps the recirculation arrangement tee in the established rotational orientation.
Aspect 22. The water recirculation system of aspect 21, wherein the first condition is a loose state.
Aspect 23. The water recirculation system of aspect 21, wherein the second condition is a tightened state.
Aspect 24. The water recirculation system of aspect 21, wherein the pressure relief mechanism is a thermal expansion tank, a thermal relief valve, or a thermal expansion ball valve.
Aspect 25. The water recirculation system of aspect 21, wherein the pressure relief mechanism is adapted to be vertically mounted when the pressure relief mechanism is coupled to the first port.
Aspect 26. The water recirculation system of aspect 21, wherein the water inlet conduit forms a cold-water inlet for the water heater.
Aspect 27. The water recirculation system of aspect 21, wherein the recirculation arrangement tee is generally T-shaped.
Aspect 28. The water recirculation system of aspect 21, wherein the first port and the fourth port are aligned with one another.
Aspect 29. The water recirculation system of aspect 21, wherein the first and second ports include female threads.
Aspect 30. The water recirculation system of aspect 21, wherein the recirculation pipe is configured for hot water recirculation through the water heater.
Aspect 31. The water recirculation system of aspect 21, further comprising a threaded component attachable to the first and second ports for providing male and/or female threaded connections.
Aspect 32. The water recirculation system of aspect 31, wherein the threaded component is a ¾ inch female threaded coupling.
Aspect 33. The water recirculation system of aspect 31, wherein the threaded component is a ¾ inch male threaded nipple.

From the forgoing detailed description, it will be evident that modifications and variations can be made without departing from the spirit and scope of the disclosure.

1. A water piping system comprising:
a prefabricated fitting tee for use with a water heater, the prefabricated fitting tee including:
a fitting tee body having a first port, a second port, and a third port, the first and third ports being aligned along a main axis and the second port being aligned along an axis angled relative to the main axis, the fitting tee body defining an interior passageway that is in fluid communication with the first, second, and third ports, wherein one of the first and second ports is configured for connecting to a water inlet conduit for supplying water from an external source, wherein the other one of the first and second ports is configured for connecting to a pressure relief or pressure absorption mechanism, and wherein the prefabricated fitting tee does not include a check valve for preventing flow from the first port to the third port and no check valve for preventing flow from the second port to the third port; and
a swivel nut rotatably mounted at the third port of the prefabricated fitting tee to provide an interconnection to the water heater, wherein, when the swivel nut is in a first condition, the swivel nut allows the prefabricated fitting tee to be rotated relative to the water heater about the main axis to allow a rotational orientation of the second port to be established, and wherein, when the swivel nut is in a second condition, the swivel nut clamps the prefabricated fitting tee in the established rotational orientation.

2. (canceled)

3. (canceled)

4. The water piping system of claim 1, wherein the pressure relief mechanism is a thermal expansion tank, a thermal relief valve, or a thermal expansion ball valve.

5. The water piping system of claim 1, wherein the pressure relief mechanism is adapted to be horizontally mounted when the pressure relief mechanism is coupled to the second port and the water inlet conduit is coupled to the first port.

6. The water piping system of claim 1, wherein the pressure relief mechanism is adapted to be vertically mounted when the pressure relieve mechanism is coupled to the first port and the water inlet conduit is coupled to the second port.

7. The water piping system of claim 1, wherein the water inlet conduit forms a cold-water inlet for the water heater.

8. (canceled)

9. The water piping system of claim 1, wherein the first port and the third port are aligned with one another.

10. The water piping system of claim 1, wherein the first and second ports include female threads.

11. A component connection system comprising:
a prefabricated fitting tee having a fitting tee body that includes a first port, a second port, and a third port, the first and third ports being aligned along a main axis and the second port being aligned along an axis angled relative to the main axis, the fitting tee body defining an interior passageway that is in fluid communication with the first, second, and third ports, wherein one of the first and second ports are configured for connecting to a water inlet conduit for supplying water from an external source;
a water inlet conduit connected to one of the first and second ports for supplying water from an external source, and a pressure relief mechanism being provided at the other one of the first and second ports, wherein the prefabricated fitting tee does not include a check valve for preventing flow from the first port to the third port and no check valve for preventing flow from the second port to the third port;
a swivel nut rotatably mounted at the third port of the prefabricated fitting tee to provide an interconnection to the water heater, wherein, when the swivel nut is in a first condition, the swivel nut allows the prefabricated fitting tee to be rotated relative to the water heater about the main axis to allow a rotational orientation of the second port to be established, and wherein, when the swivel nut is in a second condition, the swivel nut clamps the prefabricated fitting tee in the established rotational orientation; and
a threaded component attachable to the first and second ports for providing male and/or female threaded connections.

12. The component connection system of claim 11, wherein the threaded component is a ¾ inch female threaded coupling.

13. The component connection system of claim 11, wherein the threaded component is a ¾ inch male threaded nipple.

14. (canceled)

15. (canceled)

16. The component connection system of claim 11, wherein the pressure relief mechanism is a thermal expansion tank, a thermal relief valve, or a thermal expansion ball valve.

17. The component connection system of claim 11, wherein the pressure relief mechanism is adapted to be horizontally mounted when the pressure relief mechanism is coupled to the second port and the water inlet conduit is coupled to the first port.

18. The component connection system of claim 11, wherein the pressure relief mechanism is adapted to be vertically mounted when the pressure relieve mechanism is coupled to the first port and the water inlet conduit is coupled to the second port.

19. The component connection system of claim 11, wherein the prefabricated tee fitting is generally T-shaped, wherein the first port and the third port are aligned with one another.

20. (canceled)

21. A water recirculation system including a recirculation arrangement tee for use with a water heater, the hot water recirculation system comprising:
a recirculation arrangement tee including a fitting tee body, the fitting tee body defining an interior passageway in fluid communication with a first port, a second port, a third port, and a fourth port defined by the recirculation arrangement tee, the first and fourth ports being aligned along a main axis, and the second and third ports being aligned along an axis angled relative to the main axis, wherein the first port provides a connection for a pressure relief mechanism, the second port provides a connection for a water inlet conduit, the third port provides a connection to a recirculation pipe, and the fourth port provides a connection to the water heater, wherein the recirculation arrangement tee does not include a check valve for preventing flow from the first port to the fourth port and no check valve for preventing flow from the second port to the fourth port; and
a swivel nut rotatably mounted at the fourth port of the recirculation arrangement tee to provide an interconnection to the water heater, wherein, when the swivel nut is in a first condition, the swivel nut allows the recirculation arrangement tee to be rotated relative to the water heater about the main axis to allow a rotational orientation of the second and third ports to be established, and wherein, when the swivel nut is in a second condition, the swivel nut clamps the recirculation arrangement tee in the established rotational orientation.

22. (canceled)

23. (canceled)

24. The water recirculation system of claim 21, wherein the pressure relief mechanism is a thermal expansion tank, a thermal relief valve, or a thermal expansion ball valve.

25. The water recirculation system of claim 21, wherein the pressure relief mechanism is adapted to be vertically mounted when the pressure relief mechanism is coupled to the first port.

26. (canceled)

27. (canceled)

28. The water recirculation system of claim 21, wherein the first port and the fourth port are aligned with one another.

29. (canceled)

30. The water recirculation system of claim 21, wherein the recirculation pipe is configured for hot water recirculation through the water heater.

31. The water recirculation system of claim 21, further comprising a threaded component attachable to the first and second ports for providing male and/or female threaded connections.

32. (canceled)

33. (canceled)
